(19) United States
(12) Patent Application Publication
(10) Pub. No.: US 2021/0157519 A1
(43) Pub. Date: May 27, 2021

(54) SOLID-STATE DRIVE (SSD) WITH A STORAGE CONTROLLER EMPLOYING DIFFERENTIAL TWO-WIRE SERIAL BUSES TO ACCESS FLASH MEMORY

(71) Applicant: Microsoft Technology Licensing, LLC, Redmond, WA (US)

(72) Inventor: Dillip DASH, San Diego, CA (US)

(21) Appl. No.: 16/695,366

(22) Filed: Nov. 26, 2019

(51) Int. Cl. G06F 3/06

(52) U.S. Cl. CPC G06F 3/0659; G06F 3/0616; G06F 2211/002; G06F 3/0613; G06F 3/0679

(57) ABSTRACT

A solid-state drive (SSD) includes a storage control circuit coupled to each FLASH memory in the SSD via a differential two-wire transmit bus and a differential two-wire return bus. The storage control circuit receives memory instructions from a processing system, determines a corresponding FLASH instruction, generates a transmit packet including the determined FLASH instruction, and serially transmits the generated transmit packet including the FLASH instruction to a FLASH memory via the transmit bus. A FLASH memory serially transmits return packets to the storage control circuit via the return bus. A return packet may be sent in response to a transmit packet, and include a response indicating whether a transmit packet was successfully received. The return packet may include data that was requested by a FLASH instruction. The return packet from the FLASH memory may not be in response to a transmit packet or FLASH instruction.

### FIELD OF THE DISCLOSURE

The technology of the disclosure relates to solid-state drives (SSDs) that store data in non-volatile memory (e.g., FLASH memory) and more particularly to interfaces within SSDs for accessing the non-volatile memory.

### BACKGROUND

Solid-state drives (SSDs) are an example of semiconductor-based data storage devices employing non-volatile memory (NVM) dies in FLASH memories providing long term data storage. NVM dies retain data stored therein in the absence of a power supply, similar to a rotating magnetic disk drive (“disk drive”). SSDs are widely employed in laptops, tablets, and other mobile devices as an alternative to disk drives for their speed, storage capacity, and low power consumption. A SSD couples to a processing system via a system interface, such as a Peripheral Component Interface Express (PCIe) interface, Serial Advanced Technology Attachment (SATA) interface, SATA Express interface, etc. A storage controller on the SSD receives memory access instructions from the system over the system interface and responds by forwarding FLASH instructions for accessing memory in the FLASH memories. The storage controller communicates with each of the FLASH memories over an interface (“FLASH interface”) such as an Open NAND FLASH Interface (ONFI) or Toggle Double Data Rate (DDR) interface, for example.

The storage controller and FLASH memories of a SSD are located on a substrate, such as a printed circuit board (PCB), with interconnects for the FLASH interfaces routed on the substrate. For a typical FLASH interface having in the range of about 40 wires (traces) per FLASH chip, a SSD with a number (“N”) of FLASH memories includes at least 40×N interconnects to the storage controller, in addition to power, ground, and other signals routed on the substrate. Routing congestion makes it difficult to place FLASH memories close together on a substrate, which can force the traces to be routed in long, non-optimal paths. Traces having long paths may have a lower quality of data transmission reliability than traces having shorter paths. Long traces also have higher capacitance, which causes higher power consumption in the FLASH interface. Power consumption in the FLASH interface is exacerbated by some aspects of an interface protocol between the storage controller and the FLASH memories. One aspect of the interface protocol causing high power consumption is the polling required by a storage controller to obtain an indication that a memory access instruction sent to a FLASH memory has been completed. To minimize latency, the polling must be repeated frequently until the storage controller receives an indication of completion.

### SUMMARY

Aspects disclosed herein include a solid-state drive (SSD) with a storage controller employing differential two-wire serial buses to access FLASH memory. A SSD having reduced routing congestion and lower power consumption, as disclosed herein, includes an exemplary storage control circuit coupled to each FLASH memory in the SSD via a differential two-wire transmit bus and a differential two-wire return bus. The storage control circuit receives memory instructions from a processing system, determines a corresponding FLASH instruction, generates a transmit packet including the FLASH instruction, and serially transmits the transmit packet including the FLASH instruction to a FLASH memory via the transmit bus. The FLASH memory serially transmits return packets to the storage control circuit via the return bus. A return packet transmitted from the FLASH memory may be in response to a transmit packet, and may include a response indicating whether the transmit packet was received successfully or the return packet may include data stored in the FLASH memory that was requested by a FLASH instruction in the transmit packet. The return packet sent from the FLASH memory may not be in response to a transmit packet or FLASH instruction. For example, the return packet may contain information, such as a state of the FLASH memory. Information in the return packet may be an instruction to the storage control circuit initiated by the FLASH memory.

In one aspect a SSD circuit is disclosed. The SSD circuit includes a system interface configured to couple to a processing system, a FLASH memory configured to store data, a differential two-wire transmit (Tx) bus coupled to the FLASH memory, a differential two-wire return (Rx) bus coupled to the FLASH memory, and a storage control circuit coupled to the system interface, the Tx bus, and the Rx bus. The storage control circuit is configured to receive a memory instruction from the processing system, determine a FLASH instruction corresponding to the memory instruction, generate a transmit packet comprising the FLASH instruction, and serially transmit the transmit packet on the Tx bus to the FLASH memory.

In another aspect, a method in a SSD circuit is disclosed. The method includes receiving, in a storage control circuit coupled to a system interface, a memory instruction from a processing system, determining, in the storage control circuit, a FLASH instruction corresponding to the received memory instruction, generating, in the storage control circuit, a transmit packet comprising the determined FLASH instruction, and serially transmitting the generated transmit packet on a differential two-wire Tx bus from the storage control circuit to a FLASH memory.

In another aspect, a storage control circuit in a SSD circuit is disclosed. The storage control circuit includes a system interface circuit configured to receive a memory instruction from a processing system, a memory control circuit, and a serial transmit bus circuit. The memory control circuit is configured to determine a FLASH instruction corresponding to the memory instruction and generate a transmit packet comprising the FLASH instruction. The serial transmit bus circuit is configured to serially transmit, to a FLASH memory, the transmit packet on a differential two-wire Tx bus.

In another aspect, a FLASH memory in a SSD circuit is disclosed. The FLASH memory includes at least one non-volatile memory (NVM) die configured to store data, a serial transmit bus circuit configured to receive a transmit packet comprising a FLASH instruction on a differential two-wire Tx bus, a FLASH control circuit, and a serial return bus circuit. The FLASH control circuit is configured to access the at least one NVM die in response to the FLASH instruction in the transmit packet, and generate a return packet. The serial return bus circuit is configured to serially transmit, to a storage control circuit, the generated return packet.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a schematic diagram of a solid-state device (SSD) including a storage controller coupled to FLASH memories by conventional FLASH interfaces, each FLASH memory including two non-volatile memory (NVM) die sets and each NVM die set coupled to one of the conventional FLASH interfaces;

FIG. 2 is a schematic diagram of one of the FLASH memories in FIG. 1 with each die set coupled to a conventional FLASH interface including unidirectional control signals, differential control signals, and a parallel bidirectional bus;

FIG. 3 is a schematic diagram of an exemplary FLASH memory having two die sets, and each die set is coupled to an exemplary FLASH interface including a differential two-wire transmit bus and a differential two-wire return bus;

FIG. 4 is a schematic diagram of an exemplary SSD including a storage control circuit coupled to a plurality of FLASH memories by the exemplary FLASH interfaces in FIG. 3 each including a differential two-wire transmit bus and a differential two-wire return bus;

FIG. 5 is a flowchart illustrating a method in a SSD, including a storage control circuit receiving a memory instruction from a processing system and transmitting a transmit packet including a FLASH instruction to a FLASH memory via the differential two-wire transmit bus in FIG. 4;

FIG. 6A is a diagram illustrating a format of a transmit packet or return packet including an instruction serially transmitted between the storage control circuit and the FLASH memory on one of the differential two-wire transmit bus and the differential 2-wire return bus in FIG. 3;

FIG. 6B is a diagram illustrating a format of a transmit packet or return packet including a response to an instruction on one of the differential two-wire transmit bus and the differential two-wire return bus in FIG. 3;

FIG. 7 is a block diagram of circuits of an exemplary storage control circuit in the SSD including a differential two-wire transmit bus and a differential two-wire return bus as shown in FIG. 4;

FIG. 8 is a block diagram of circuits of an exemplary FLASH memory in the SSD including a differential two-wire transmit bus and a differential two-wire return bus as shown in FIG. 4; and

FIG. 9 is a block diagram of an exemplary processor-based system including the exemplary SSD including a storage control circuit coupled to FLASH memories by a differential two-wire transmit bus and a differential two-wire return bus as shown in FIG. 4.

### DETAILED DESCRIPTION

Aspects disclosed herein include a solid-state drive (SSD) with a storage controller employing differential two-wire serial buses to access FLASH memory. A SSD having reduced routing congestion and lower power consumption, as disclosed herein, includes an exemplary storage control circuit coupled to each FLASH memory in the SSD via a differential two-wire transmit bus and a differential two-wire return bus. The storage control circuit receives memory instructions from a processing system, determines a corresponding FLASH instruction, generates a transmit packet including the FLASH instruction, and serially transmits the generated transmit packet including the FLASH instruction to a FLASH memory via the transmit bus. The FLASH memory serially transmits return packets to the storage control circuit via the return bus. A return packet transmitted from the FLASH memory may be in response to a transmit packet, and may include a response indicating whether the transmit packet was successfully received or the return packet may include data stored in the FLASH memory that was requested by a FLASH instruction in the transmit packet. The return packet sent from the FLASH memory may not be in response to a transmit packet or FLASH instruction. For example, the return packet may contain information, such as a state of the FLASH memory. Information in the return packet may be an instruction to the storage control circuit initiated by the FLASH memory.

FLASH memory is an electronic non-volatile memory (NVM) medium that can be electrically accessed using program (write), read, and erase instructions (FLASH instructions). Examples of FLASH memory include NAND and NOR logic circuits implemented in semiconductor devices on FLASH dies. A FLASH memory as referred to herein is a chip, package, or device including one or more FLASH dies and electronic circuits for accessing memory in the FLASH dies in response to FLASH instructions. FLASH memory is employed in a SSD to provide memory space to store and retrieve data for a processing system.

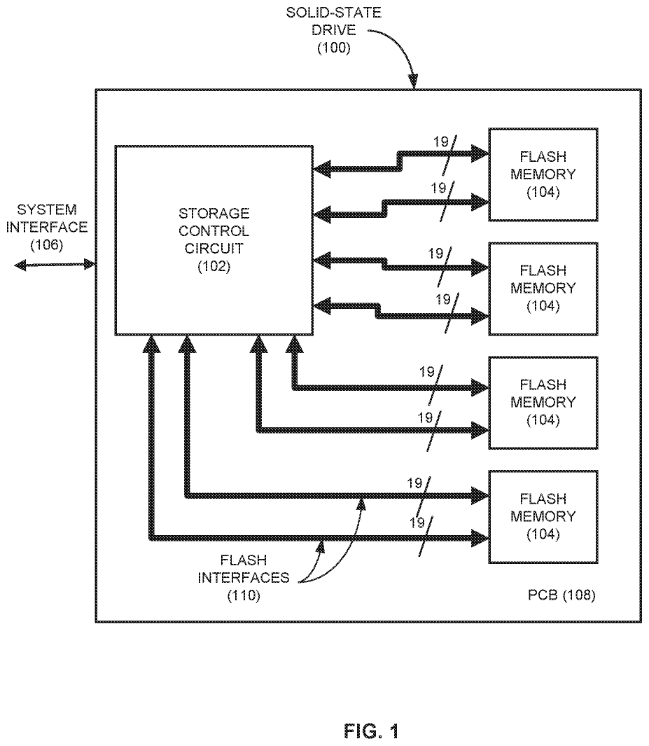

FIG. 1 is a schematic diagram of a conventional SSD circuit 100 (“SSD 100”) including a storage control circuit 102 and a number of FLASH memories 104 for data storage. The SSD 100 includes a system interface 106 for bidirectional communication with a processing system (not shown), such as a computer, mobile device, or other electronic device including a processor. The SSD 100 may be included in or coupled to the processing system. A user application or process running in the processing system fetches instructions and/or data from a data storage device such as the FLASH memories 104. The instructions and data may be stored in NVM in the FLASH memories 104, where the data will be retained even if no power is provided to the SSD 100. The processing system accesses the FLASH memories 104 by sending a memory instruction on the system interface 106. For example, the memory instruction may request data stored in an addressable location in the FLASH memories 104. The SSD 100 returns the requested data to the processing system over the system interface 106. In another example, the memory instruction may be a request to store data to a location in the FLASH memories 104, and the processing system may require a confirmation that the data has been stored. The SSD 100 will send a confirmation over the system interface 106. The system interface 106 may be a Peripheral Component Interface Express (PCIe) interface employing the Non-Volatile Memory Express (NVMe) protocol, for example. Other examples of the system interface 106 are a Serial Advanced Technology Attachment (SATA) interface, SATA Express interface, etc. Any system interface 106 may be used to interface with the SSD 100.

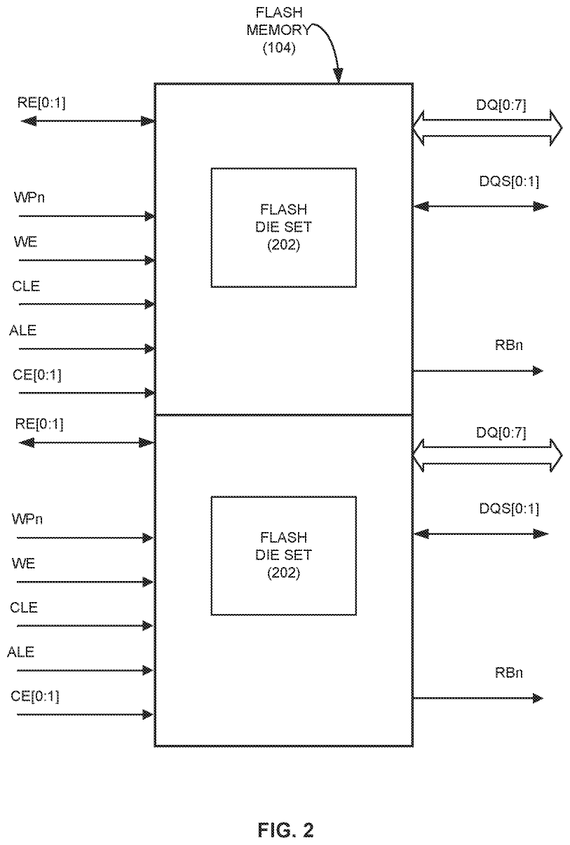

In some situations, the SSD 100 is included inside a housing of the processing system. In this regard, it would be preferable for the SSD 100 to be as small as possible. Reduced size also helps to reduce cost of the SSD 100. The SSD 100 in this example includes a printed circuit board (PCB) 108 or other substrate with the storage control circuit 102 in the form of a chip or package mounted on a surface of the PCB 108. The FLASH memories 104 are also mounted on the PCB 108. The storage control circuit 102 is coupled to each of the FLASH memories 104 by a conventional FLASH interface 110. In the example shown in FIG. 1, the FLASH memories 104 include two separate FLASH interfaces 110, as explained below with regard to FIG. 2. One example of a conventional FLASH interface 110 is the Open NAND FLASH Interface (ONFI) standard interface which includes nineteen (19) conductors, wires, or traces for a plurality of unidirectional signals, differential control signals, and a bidirectional parallel data bus, as shown in FIG. 2.

A problem with reducing the size of the SSD 100 in FIG. 1 is that, for each of the four (4) FLASH memories 104 mounted on the PCB 108 in this example, there are thirty-eight (38) traces routed to the storage control circuit 102 along a surface of the PCB 108. As the FLASH memories 104 are placed closer together to minimize the two-dimensional area of the PCB 108, the traces are crowded together. This crowding, known as routing congestion, is a problem that becomes more significant as the number of FLASH memories 104 on the PCB 108 increases. A high number of traces may require the FLASH memories 104 to be placed farther apart to reduce routing congestion, which makes the SSD 100 larger and increases the lengths of the traces. As the lengths of the traces increase, trace capacitance increases, which causes more power to be consumed each time a signal is driven over the traces.

Another problem with the SSD 100, in which the storage control circuit 102 is coupled to the FLASH memories 104 by a conventional FLASH interface 110, is due to a protocol for the storage control circuit 102 to access memory in the FLASH memories 104. In particular, when the storage control circuit 102 sends a FLASH instruction (e.g., a program instruction) to a FLASH memory 104 for the FLASH memory 104 to execute internally, the FLASH memory 104 does not indicate to the storage control circuit 102 whether the FLASH instruction was successfully received or when the FLASH instruction has been completed by the FLASH memory 104. To determine the outcome of the FLASH instruction sent to the FLASH memory 104, the storage control circuit 102 issues a polling instruction to read a status register internal to the FLASH memory 104. If the FLASH instruction is successfully received, the FLASH memory 104 sets the status bit to a known value when the instruction is successfully completed. Until a successfully received instruction has completed, the storage control circuit 102 will periodically issue a polling instruction to request (i.e., poll) the value of the status bit in the FLASH memory 104. Each of such polling instructions consumes power on the FLASH interface 110. Increasing the period of such polling, so polling events occur less frequently, reduces power consumption, but increases latency associated with the FLASH instruction. Thus, to achieve the shortest memory access times, a large amount of power may be consumed due to polling under the conventional FLASH interface protocol.

FIG. 2 is a schematic diagram of one of the conventional FLASH memories 104 in FIG. 1. The FLASH memory 104 in FIG. 2 is divided into two independent halves that function independently of each other. Each half includes a FLASH die set 202, which may include one or more FLASH dies for storing data in circuits forming pages, blocks, and planes of NVM. The FLASH die sets 202 in each half of the FLASH memory 104 have independent FLASH interfaces 110 to the storage control circuit 102, as noted above. Thus, the storage in the FLASH die sets 202 can be independently accessed. As an example of the FLASH interface 110, the individual signals of the ONFI interface are shown and labeled in FIG. 2. However, the details of this specific example are beyond the scope of this disclosure as ONFI is a well-known FLASH interface 110 and is, therefore, not discussed in detail herein. FIG. 2 illustrates that a high number of traces in the FLASH interface 110 causes congestion between the FLASH memories 104 and the storage control circuit 102 in the SSD 100.

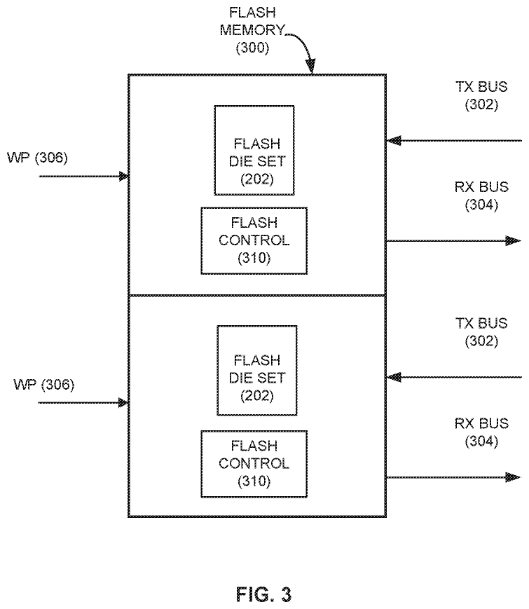

FIG. 3 is a schematic diagram of an exemplary FLASH memory 300 including the FLASH die sets 202 in FIG. 2. The FLASH memory 300 also provides features for overcoming the problems discussed above with the SSD 100 in FIG. 1. To reduce routing congestion, the number of traces used for each FLASH die set 202 in the FLASH memory 300 is significantly reduced. As shown in FIG. 3, each FLASH die set 202 of the FLASH memory 300 is coupled to a differential two-wire transmit (Tx) bus 302, a differential two-wire return (Rx) bus 304, and a write-protect (WP) signal 306. Each half of the FLASH memory 300 also includes a FLASH control circuit 310 (“FLASH control 310”) for controlling access to the FLASH die set 202. The Tx bus 302 and the Rx bus 304 are each a two-wire bus on which a signal can be reliably transmitted as a difference in voltage between the two wires indicating a value (e.g., a binary value) of the signal. The FLASH control 310 includes circuits to receive a serially-transmitted differential signal on the Tx bus 302 and serially transmit a differential signal on the Rx bus 304. The WP signal 306 in each half of the FLASH memory 300 is an input used to activate or deactivate reception of a signal on the Tx bus 302. In some examples within the scope of the present disclosure, other signals may be provided in addition to or in the alternative to the WP signal 306, shown herein. Such other signals may be determined according to vendor requirements, for example, to be used with the Tx bus 302 and the Rx bus 304 as disclosed herein.

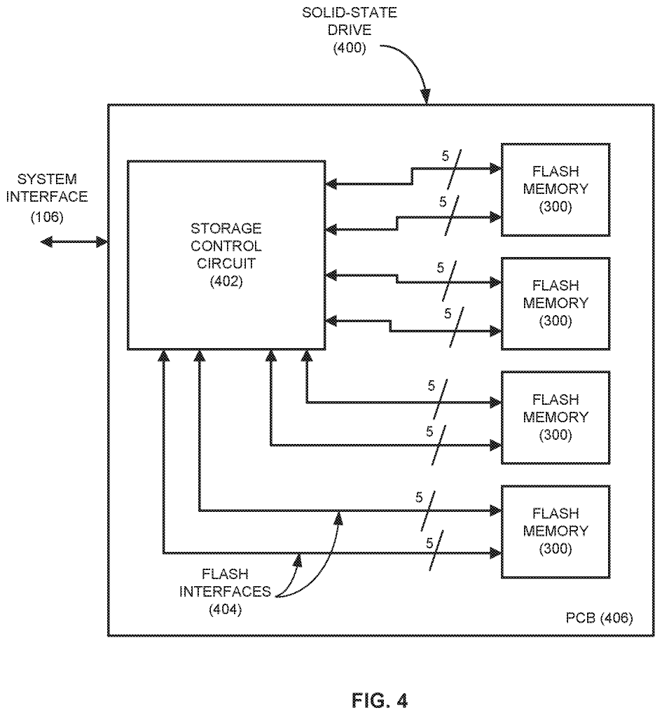

Compared to the nineteen (19) traces of an ONFI interface, the five (5) traces in the FLASH interfaces 404 between each FLASH die set 202 of the FLASH memories 300 allows the SSD circuit 400 (“SSD 400”) in FIG. 4 to have significantly less routing congestion than the SSD 100 in FIG. 1. Specifically, the total number of traces employed in the FLASH interfaces 110 in the SSD 100 in FIG. 1 is 19 traces×8 FLASH interfaces=152 traces and the total number of traces employed in the FLASH interfaces 404 in the SSD 400 in FIG. 4 is 5 traces×8 FLASH interfaces=40 traces. On a PCB 406 in FIG. 4, having 112 fewer traces than the PCB 108 in FIG. 1, less space is required for traces, so the FLASH memories 300 can be placed closer to the storage control circuit 402. This allows the SSD 400 in FIG. 4 to be smaller and the traces to be shorter than in the SSD 100 in FIG. 1, thereby consuming less power.

In another aspect, the power consumed due to polling in the conventional FLASH interface is avoided. After receiving a FLASH instruction on the Tx bus 302, the FLASH control 310 may continue to receive transmissions on the Tx bus 302 while generating and transmitting a response to the storage control circuit 402 on the Rx bus 304. As described in more detail below, the Rx bus 304 may be used to serially transmit a response to a FLASH instruction, such as an acknowledgement indicating that the FLASH instruction is received. Alternatively, or additionally, the Rx bus 304 may be used by the FLASH memory 300 to inform the storage control circuit 402 that a FLASH instruction has been completed. In this regard, there is no need for the storage control circuit 402 to repeatedly issue polling instructions to the FLASH memory 300 for status information, which conserves power.

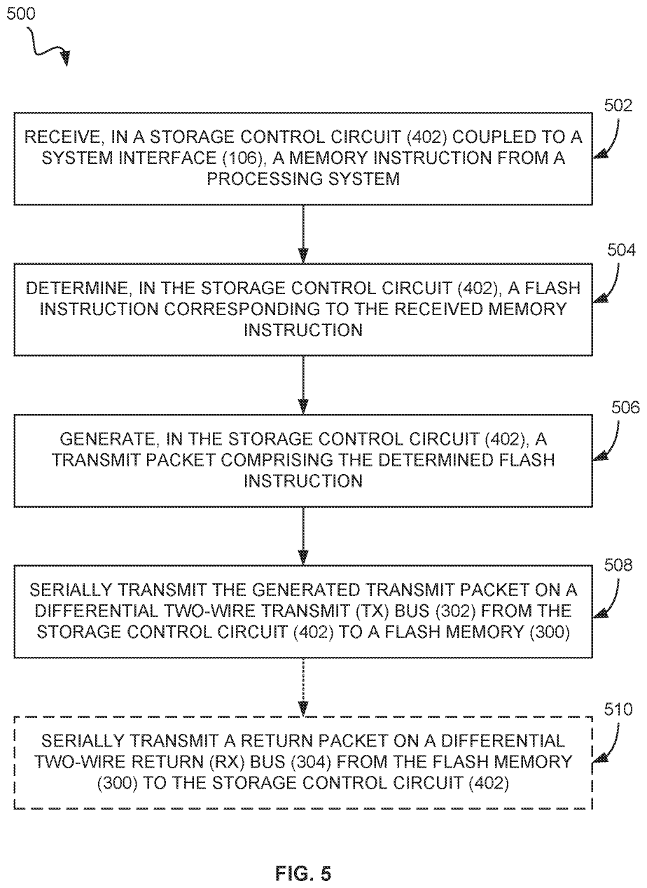

Communication between the storage control circuit 402 and the FLASH memories 300 over the FLASH interfaces 404 for accessing memory in the FLASH die sets 202 is described with reference to FIG. 5. FIG. 5 is a flowchart illustrating a method 500 of accessing memory in the SSD 400 in FIG. 4. In particular, the method 500 includes receiving, in the storage control circuit 402 coupled to the system interface 106, a memory instruction from a processing system (block 502). The method 500 further includes determining, in the storage control circuit 402, a FLASH instruction corresponding to the received memory instruction (block 504). The method 500 further includes generating, in the storage control circuit 402, a transmit packet comprising the determined FLASH instruction (block 506). The method 500 further includes serially transmitting the generated transmit packet on a differential two-wire Tx bus 302 from the storage control circuit 402 to a FLASH memory 300 (block 508). Optionally, the method 500 of accessing memory in the SSD 400 may further include transmitting a return packet on a differential two-wire Rx bus 304 from the FLASH memory 300 to the storage control circuit 402 (block 510).

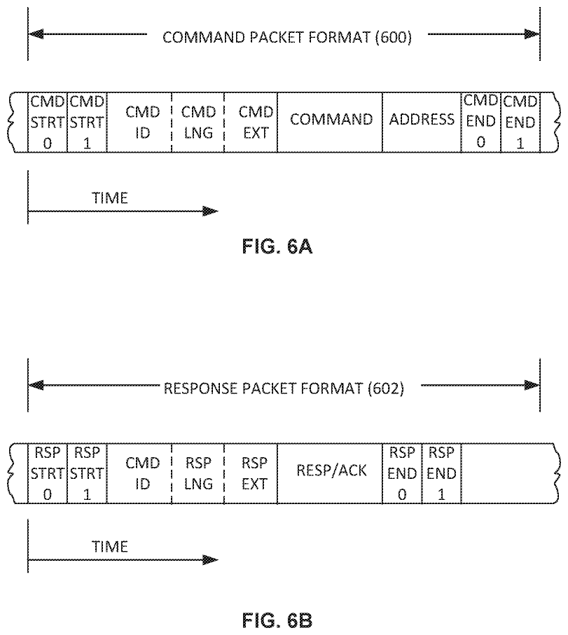

FIG. 6A is a diagram illustrating a command packet format 600, which is one example of a packet within the scope of the SSD 400. Either a transmit packet or a return packet that includes a command or instruction is generated in the command packet format 600. A transmit packet or return packet is a sequence of fields concatenated together in a continuous block for serial transmission on the Tx bus 302 or Rx bus 304. The fields each include information indicated by a sequence of binary digits or bits. Thus, the transmit packet or return packet is a sequence of bits that may be transmitted sequentially or serially (i.e., one bit at a time) on the Tx bus 302 or Rx bus 304. For each of the Tx bus 302 and the Rx bus 304, the bits are transmitted by setting a differential voltage of the two wires of the bus to indicate the value of a first bit for a period of time, setting a differential voltage of the two wires on the bus to indicate the value of the next bit for a next period of time, and so on for each bit for respective periods of time in order for all the bits in the packet. In other examples, the transmit packet and the return packet may have different formats from each other and the formats may be different than are shown in this example.

The fields of the command packet format 600 in the example in FIG. 6A are shown in chronological order from left to right, as follows:

CMD STRT [0:1]: Bytes indicating start of command packet format 600;

CMD ID: Unique Identifier for a particular command ;

CMD LNG: Optional Length indication;

CMD EXT: Optional Extension information;

COMMAND: Actual Command ;

ADDRESS: Memory/Register as command source/destination; and

CMD END [0:1]: Bytes indicating end of command packet format 600.

FIG. 6B is a diagram illustrating a response packet format 602. Either a return packet or a transmit packet including a response to an instruction will have the response packet format 602. The response packet format 602 is used for a response to a command or instruction received in a command packet format 600. The fields of the response packet format 602 in the example in FIG. 6B are shown in chronological order from left to right, as follows:

RSP STRT [0:1]: Bytes indicating start of response packet format 602;

CMD ID: Identifier of the command associated with this response;

RSP LNG: Optional Length indication;

RSP EXT: Optional Extension information;

RESP/ACK: Content of Response (e.g., ACK/NACK or requested data); and

RSP END [0:1]: Bytes indicating end of response packet format 602.

Some of the lengths of the fields in FIGS. 6A and 6B are not shown because they may vary as the number of bits/bytes needed to uniquely indicate such information may vary according to vendor or for other reasons. The fields and field identifiers of the command packet format 600 and the response packet format 602 illustrated in FIGS. 6A and 6B are examples, and the present disclosure is not limited to such examples.

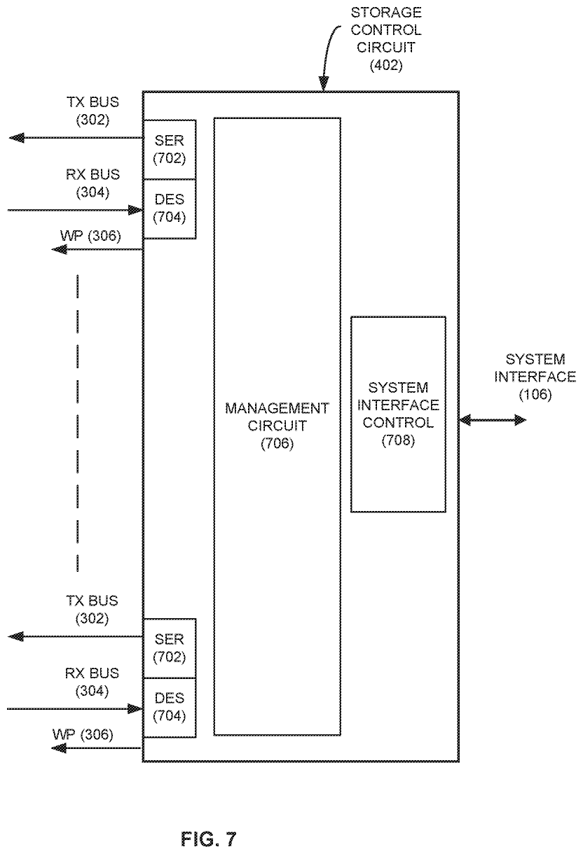

In the SSD 400 in FIG. 4, the storage control circuit 402 employs the FLASH interface 404 to access memory in the FLASH memories 300 by the method 500 illustrated in FIG. 5. The FLASH interface 404 transfers transmit packets and return packets having the command packet format 600 and the response packet format 602 as illustrated in FIG. 6. To transfer the transmit packets and return packets on the Tx bus 302 and the Rx bus 304, the storage control circuit 402 includes a serial Tx bus circuit serializer (SER) 702 and a serial Rx bus circuit deserializer (DES) 704, as shown in FIG. 7. The SER 702 serializes binary data (i.e., a transmit packet in the command packet format 600 or the response packet format 602) stored (e.g., in parallel) in buffers or registers in the storage control circuit 402 for transmission on the Tx bus 302. Serializing the binary data refers to obtaining the values of binary bits in order one at a time (e.g., each period or clock cycle) from a buffer or register. The SER 702 presents the binary values in sequential order on the Tx bus 302 as differential voltages, as described above. The DES 704 recognizes the binary value presented on the Rx bus 304 each cycle. Deserializing binary data refers to capturing the binary values of a packet each cycle in sequential order and storing the bits of the return packet in order (e.g., in parallel) in a buffer or register. The SER 702 and DES 704 may also incorporate error detection and correction capabilities. For example, the SER 702 may employ logic circuits for adding error correction codes (ECCs) into the command packet format 600 or the response packet format 602. This allows the DES 704 to verify that data has been successfully transmitted over the Rx bus 304, and correct errors according to the error codes employed.

The SER 702 serializes data in the form of transmit packets obtained from a management circuit 706, and the DES 704 deserializes data of return packets received on the Rx bus 304 to the management circuit 706. The storage control circuit 402 also includes a system interface control 708 to handle bidirectional communication on the system interface 106. The management circuit 706 receives memory instructions from the system interface control 708, and provides responses to such memory instructions back to the system interface control 708 for transmission to the processing system. The management circuit 706 employs internal controllers and/or state machine logic (not shown) to interpret memory instructions received from the processing system. The management circuit 706 works together with the FLASH memory 300 to manage the NVM in the FLASH die sets 202.

For example, a memory instruction from the processing system may instruct the SSD 400 to write data into a page of NVM at a particular memory location. In response, the management circuit 706 may need to read data that is already stored in such page of the NVM, merge the data read from the page with the data to be written to the page, and transmit a PROGRAM instruction (command) to the FLASH memory 300 to program a page with the combined data.

The read instruction in the above example is explained in more detail. The management circuit 706 receives the memory access instruction from the processing system via the system interface 106. The management circuit 706 determines that a FLASH instruction corresponding to the received memory instruction is needed (e.g., to read data from a FLASH memory 300). The management circuit 706 generates a transmit packet in the command packet format 600, in which the COMMAND field indicates a FLASH instruction (e.g., read instruction) and the ADDRESS field indicates an address of the page of NVM to be read. The management circuit 706 determines which FLASH memory 300 contains the data that is the target of the read instruction, and provides the transmit packet to the SER 702 of the appropriate FLASH interface 404. The SER 702 serially transmits the transmit packet having the command packet format 600 on the Tx bus 302 to the FLASH memory 300. In response to the FLASH instruction (read instruction), the storage control circuit 402 will receive, on the Rx bus 304, a return packet having the response packet format 602. The return packet may contain an acknowledgement indicating whether the data has been received or the data that is the target of the read. The CMD ID field of the transmit packet contains a transmit identifier. The CMD ID field of the return packet received in response to the read instruction includes a return identifier. In order to associate the response (i.e., return packet) with the read instruction in the transmit packet, the value of the return identifier in the CMD ID field of the return packet is the same as the transmit identifier in the CMD ID field of the transmit packet.

The storage control circuit 402 may also receive return packets on the Rx bus 304 that are not in response to a FLASH instruction transmitted in a transmit packet on the Tx bus 302. Return packets that are not in response to a FLASH instruction are in the command packet format 600. Such return packets contain information or instructions from the FLASH memory 300. The information received from the FLASH memory 300 in a return packet in the command packet format 600 may be status information of the FLASH memory, for example. The instructions may be memory management instructions. For example, the FLASH memory 300 may also include memory management capabilities working cooperatively with the storage control circuit 402. Where a conventional storage control circuit 102 as shown in FIG. 1 may include memory management circuits that are repeated for each FLASH memory 104, the storage control circuit 402 may have reduced memory management because some of such repeated functions may be shifted onto the FLASH memory 300.

The storage control circuit 402 in the SSD 400 comprises a system interface circuit (e.g., the system interface control 708) configured to receive a memory instruction from a processing system. The storage control circuit 402 further includes a memory control circuit (e.g., the management circuit 706) configured to determine a FLASH instruction corresponding to the memory instruction, and generate a transmit packet comprising the FLASH instruction. The storage control circuit 402 further includes a serial transmit bus circuit (the SER 702) configured to serially transmit, to a FLASH memory 300, the transmit packet on the differential two-wire Tx bus 302. The storage control circuit 402 further includes a serial return bus circuit (the DES 704) configured to receive, from the FLASH memory 300, return packets serially transmitted on the differential two-wire Rx bus 304.

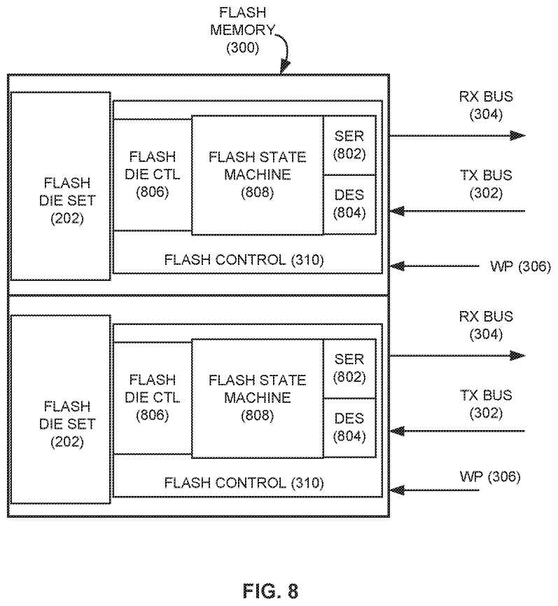

FIG. 8 is a more detailed diagram of the FLASH memory 300 in FIG. 3. As previously discussed, the FLASH memory 300 receives FLASH instructions from the storage control circuit 402 and accesses FLASH die sets 202 in response to the FLASH instructions. The FLASH die sets 202 each include one or more die therein that are capable of performing FLASH instructions such as read, program, and erase allowing the FLASH memory 300 to manage data in NVM pages, blocks, and planes. The FLASH control 310 from FIG. 3 includes a DES 804 to receive and deserialize the transmit packets received on the Tx bus 302, and a SER 802 to serialize and transmit the return packets on the Rx bus 304. The SER 802 and the DES 804 have similar capabilities to the SER 702 and the DES 704 in the storage control circuit 402 as shown in FIG. 7, including the error detection and correction capabilities. The FLASH control 310 further includes a FLASH die ctl 806 to communicate directly with the FLASH die sets 202. The FLASH control 310 further includes a FLASH state machine 808 that controls the SER 802, the DES 804, and the FLASH die ctl 806.

Continuing with the example of the read instruction discussed above with respect to FIG. 7, the FLASH memory 300 receives the transmit packet including the FLASH instruction (read instruction) via the DES 804. The DES 804 provides the transmit packet to the FLASH state machine 808 to be parsed and decoded. If the FLASH state machine 808 determines that the transmit packet is in the command packet format 600, the FLASH memory 300 responds by executing the read instruction. That is, the FLASH state machine 808 instructs the FLASH die ctl 806 to read the target data from the page of NVM in an appropriate FLASH die set 202. The FLASH state machine 808 generates a return packet in the response packet format 602 including a response to the FLASH (read) instruction. The FLASH state machine 808 then passes the return packet to the SER 802 to be serialized and serially transmitted to the storage control circuit 402 on the Rx bus 304. The return packet in the response packet format 602 includes a return identifier in the CMD ID field that corresponds to a transmit identifier in the CMD ID field of the received transmit packet. The return packet may include an acknowledgement indicating whether the transmit packet was received successfully. For example, the return packet may include an acknowledgement (ACK) indicating that the transmit packet was received successfully, or a negative acknowledgement (NACK) indicating that the transmit packet was not received successfully. The return identifier in the CMD ID field of the return packet in the response packet format 602 is the same as the transmit identifier from the transmit packet in the command packet format 600. Alternatively, in response to the read instruction, the FLASH memory 300 may generate a return packet that includes the target data stored in the FLASH memory 300 that was requested by the read instruction. In another example, the return packet may include both an ACK and the target data.

The FLASH state machine 808 may also include some of the memory management functions conventionally found in the storage control circuit 102 in FIG. 1. Thus, the FLASH state machine 808 may include a processor or other state logic that performs such functions. Memory management functions that may be handled directly by the FLASH memory 300 as a result of having the FLASH state machine 808 may include informing the storage control circuit 402 of some status in the FLASH memory 300 or requesting the storage control circuit 402 to perform a memory management function. Thus, the FLASH state machine 808 is also configured to generate a return packet that is not in response to a FLASH instruction or transmit packet received from the storage control circuit 402. The FLASH state machine 808 may generate a return packet in the command packet format 600 in which the COMMAND field contains a command or information for the storage control circuit 402. The return packet in the command packet format 600 also includes a return identifier in the CMD ID field, and the storage control circuit 402 responds to such return packet with a transmit packet in the response packet format 602 in which the transmit identifier in the CMD ID field is the return identifier from the return packet, indicating that this transmit packet is in response to the return packet.

As a result of incorporating the FLASH state machine 808, the FLASH memory 300 may internally support other memory management functions that may have previously been managed by conventional SSDs. In one example, a FLASH memory 300 can execute read instructions in a short amount of time, but program and erase instructions take a much longer time to complete. Forcing a read instruction to be sequentially executed (i.e., by waiting until a program or erase is complete) would cause excessive latency. The FLASH memory 300 may internally support suspending a longer executing instruction temporarily to allow the read instruction to complete, and then resuming execution of the longer operation. In another example, functions requiring information about the internal mapping of memory in a FLASH die can be handled more easily within the FLASH memory 300 than in a storage controller. Asynchronous Independent Plane Read (AIPR) and Synchronous Independent Plane Read (SIPR) are examples of such functions. In addition, the FLASH state machine 808 may be able to reorder instructions for internal memory management purposes or for other high-priority purposes as needed either as determined by the FLASH state machine 808 or in response to an instruction from the storage control circuit 402. These and other fine-grained tasks of memory management may be supported directly within the FLASH memory 300 as needed.

The FLASH memory 300 in the SSD 400 includes at least one NVM die (FLASH die set 202) configured to store data, and a serial transmit bus circuit (the DES 804) configured to receive a transmit packet comprising a FLASH instruction on the differential two-wire Tx bus 302. The FLASH memory 300 also includes a FLASH control 310 configured to access the NVM die (FLASH die set 202) in response to the FLASH instruction in the transmit packet, and generate a return packet. The FLASH memory 300 also includes a serial return bus circuit (the SER 802) configured to serially transmit, to the storage control circuit 402, the generated return packet. In the FLASH memory 300, the FLASH control 310 is configured to generate, in response to the FLASH instruction, a return packet comprising a response to the FLASH instruction. The FLASH control 310 is also configured to generate, not in response to the FLASH instruction, a return packet comprising an instruction.

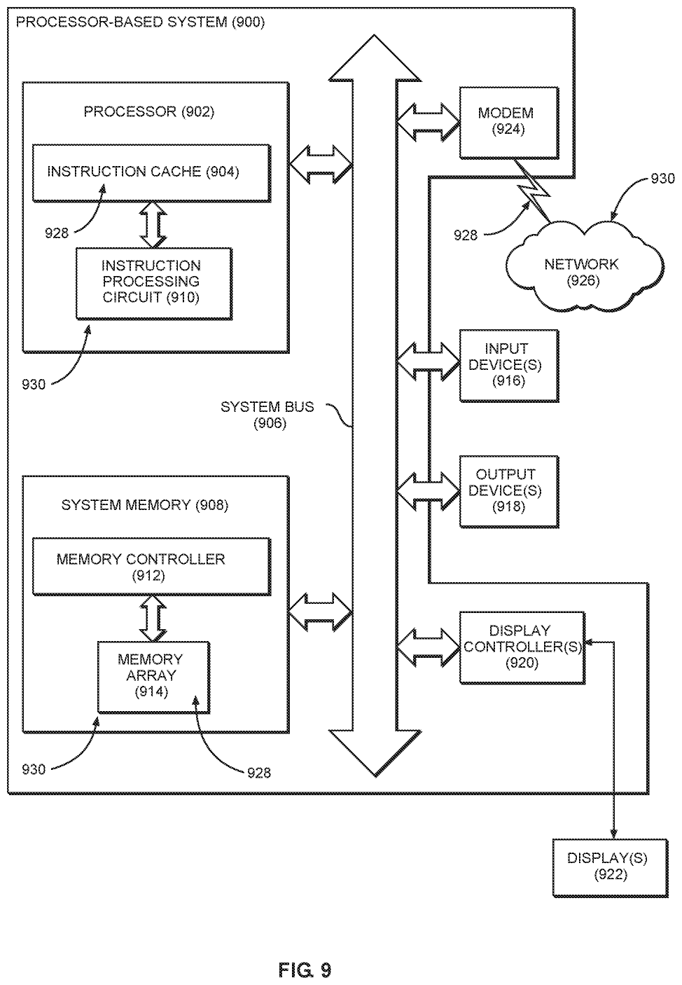

FIG. 9 is a block diagram of an exemplary processor-based system 900 that includes a processor 902 (e.g., a microprocessor) that includes an instruction processing circuit 910. The processor-based system 900 may be a circuit or circuits included in an electronic board card, such as a PCB, a server, a personal computer, a desktop computer, a laptop computer, a personal digital assistant (PDA), a computing pad, a mobile device, or any other device, and may represent, for example, a server, or a user's computer. In this example, the processor-based system 900 includes the processor 902. The processor 902 represents one or more general-purpose processing circuits, such as a microprocessor, central processing unit, or the like. The processor 902 is configured to execute processing logic in instructions for performing the operations and steps discussed herein.

The processor 902 and system memory 908 are coupled to a system bus 906 that can intercouple peripheral devices included in the processor-based system 900. As is well known, the processor 902 communicates with these other devices by exchanging address, control, and data information over the system bus 906. For example, the processor 902 can communicate bus transaction requests to a memory controller 912 in the system memory 908 as an example of a slave device. Although not illustrated in FIG. 9, multiple system buses 906 could be provided, wherein each system bus constitutes a different fabric. In this example, the memory controller 912 is configured to provide memory access requests to a memory array 914 in the system memory 908. The memory array 914 is comprised of an array of storage bit cells for storing data. The system memory 908 may be a read-only memory (ROM), FLASH memory, dynamic random access memory (DRAM), such as synchronous DRAM (SDRAM), etc., and a static memory (e.g., FLASH memory, static random access memory (SRAM), etc.), as non-limiting examples. FLASH memory in the system memory 908 may include the SSD 400 as shown in FIG. 4, including the storage control circuit 402 coupled to a FLASH memory 300, wherein the storage control circuit 402 serially transmits transmit packets to the FLASH memory 300 via a differential two-wire Tx bus 302, and the FLASH memory 300 serially transmits return packets to the storage control circuit 402 via a differential two-wire Rx bus 304.

Other devices can be connected to the system bus 906. As illustrated in FIG. 9, these devices can include the system memory 908, one or more input devices 916, one or more output devices 918, a modem 924, and one or more display controllers 920, as examples. The input device(s) 916 can include any type of input device, including, but not limited to, input keys, switches, voice processors, etc. The output device(s) 918 can include any type of output device, including, but not limited to, audio, video, other visual indicators, etc. The modem 924 can be any device configured to allow exchange of data to and from a network 926. The network 926 can be any type of network, including, but not limited to, a wired or wireless network, a private or public network, a local area network (LAN), a wireless local area network (WLAN), a wide area network (WAN), a BLUETOOTH™ network, and the Internet. The modem 924 can be configured to support any type of communications protocol desired. The processor 902 may also be configured to access the display controller(s) 920 over the system bus 906 to control information sent to one or more displays 922. The display(s) 922 can include any type of display, including, but not limited to, a cathode ray tube (CRT), a liquid crystal display (LCD), a plasma display, etc.

The processor-based system 900 in FIG. 9 may include a set of instructions 928 to be executed by the processor 902 for any application desired according to the instructions. The instructions 928 may be stored in the system memory 908, and/or instruction cache 904 of the processor 902, as examples of a non-transitory computer-readable medium 930. The instructions 928 may also reside, completely or at least partially, within the system memory 908 and/or within the processor 902 during their execution. The instructions 928 may further be transmitted or received over the network 926 via the modem 924, such that the network 926 includes computer-readable medium 930.

While the computer-readable medium 930 is shown in an exemplary embodiment to be a single medium, the term “computer-readable medium” should be taken to include a single medium or multiple media (e.g., a centralized or distributed database, and/or associated caches and servers) that stores the one or more sets of instructions. The term “computer-readable medium” shall also be taken to include any medium that is capable of storing, encoding, or carrying a set of instructions for execution by the processing device and that causes the processing device to perform any one or more of the methodologies of the embodiments disclosed herein. The term “computer-readable medium” shall accordingly be taken to include, but not be limited to, solid-state memories, optical medium, and magnetic medium.

The embodiments disclosed herein include various steps. The steps of the embodiments disclosed herein may be formed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes: a machine-readable storage medium (e.g., ROM, random access memory (“RAM”), a magnetic disk storage medium, an optical storage medium, FLASH memory devices, etc.); and the like.

Unless specifically stated otherwise and as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components of the distributed antenna systems described herein may be employed in any circuit, hardware component, IC, or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA), or other programmable logic device, a discrete gate or transistor logic, discrete hardware components, or any combination thereof designed to perform the functions described herein.

Furthermore, a controller may be a processor. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The embodiments disclosed herein may be embodied in hardware and in instructions that are stored in hardware, and may reside, for example, in RAM, FLASH memory, ROM, Electrically Programmable ROM (EPROM), Electrically Erasable Programmable ROM (EEPROM), registers, a hard disk, a removable disk, a

CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips, that may be references throughout the above description, may be represented by voltages, currents, electromagnetic waves, magnetic fields, or particles, optical fields or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

1. A solid-state drive (SSD) circuit, comprising:
a processing system interface;
a FLASH memory configured to store data;
a differential two-wire transmit (Tx) bus coupled to the FLASH memory;
a differential two-wire return (Rx) bus coupled to the FLASH memory; and
a storage control circuit coupled to the processing system interface, the Tx bus, and the Rx bus, the storage control circuit configured to:
receive a memory instruction from a processing system coupled to the processing system interface;
determine a FLASH instruction corresponding to the memory instruction;
generate a transmit packet comprising the FLASH instruction; and
serially transmit the transmit packet on the Tx bus to the FLASH memory;
wherein the FLASH memory is further configured to:
generate a return packet not in response to the FLASH instruction; and
serially transmit, on the Rx bus, the return packet comprising a return identifier.

2. The SSD circuit of claim 1, wherein the transmit packet includes a transmit identifier.

3. (canceled)

4. The SSD circuit of claim 1, wherein the FLASH memory is further configured to:
receive the transmit packet comprising the FLASH instruction; and
generate a second return packet comprising a response to the FLASH instruction.

5. The SSD circuit of claim 4, wherein the FLASH memory is further configured to generate the second return packet comprising a second return identifier corresponding to a transmit identifier.

6. The SSD circuit of claim 4, wherein the FLASH memory is further configured to generate the second return packet comprising an acknowledgement (ACK) indicating that the FLASH instruction is received successfully.

7. The SSD circuit of claim 4, wherein the FLASH memory is further configured to generate the second return packet comprising data stored in the FLASH memory in response to the FLASH instruction.

8. (canceled)

9. The SSD circuit of claim 1, wherein the FLASH memory is further configured to generate the return packet comprising an instruction to the storage control circuit.

10. The SSD circuit of claim 1, wherein the storage control circuit is further configured to transmit, on the Tx bus, an acknowledgement (ACK) transmit packet comprising an acknowledgement indicating whether the return packet is received successfully, the ACK transmit packet comprising a transmit identifier corresponding to the return identifier.

11. A method in a solid-state drive (SSD) circuit, the method comprising:
receiving, in a storage control circuit coupled to a processing system interface, a memory instruction from a processing system;
determining, in the storage control circuit, a FLASH instruction corresponding to the received memory instruction;
generating, in the storage control circuit, a transmit packet comprising the determined FLASH instruction;
serially transmitting the generated transmit packet on a differential two-wire transmit (Tx) bus from the storage control circuit to a FLASH memory;
generating a return packet not in response to the FLASH instruction; and
serially transmitting, on the Rx bus, the return packet comprising a return identifier.

12. The method of claim 11, wherein the transmit packet comprises a transmit identifier.

13. The method of claim 11, further comprising serially transmitting the return packet on a differential two-wire return (Rx) bus from the FLASH memory to the storage control circuit, the return packet comprising the return identifier.

14. The method of claim 13, further comprising:
receiving, in the FLASH memory, the transmit packet comprising the FLASH instruction; and
generating, in the FLASH memory, a second return packet comprising a response to the FLASH instruction.

15. The method of claim 14, further comprising, in the FLASH memory, generating the second return packet comprising a second return identifier corresponding to a transmit identifier.

16. The method of claim 14, further comprising, in the FLASH memory, generating the second return packet comprising an acknowledgement indicating that the FLASH instruction is received successfully.

17. The method of claim 14, further comprising, in the FLASH memory, generating the second return packet comprising data stored in the FLASH memory in response to the FLASH instruction.

18. (canceled)

19. The method of claim 11, further comprising, in the FLASH memory, generating the return packet comprising an instruction to the storage control circuit.

20. The method of claim 11, further comprising, in the storage control circuit, transmitting, on the Tx bus, an acknowledgement (ACK) transmit packet comprising an acknowledgement indicating whether the return packet is received successfully, the ACK transmit packet comprising a transmit identifier corresponding to the return identifier.

21. A storage control circuit in a solid-state drive (SSD) circuit, the storage control circuit comprising:
a processing system interface circuit configured to receive a memory instruction from a processing system;
a memory control circuit configured to:
determine a FLASH instruction corresponding to the memory instruction; and
generate a transmit packet comprising the FLASH instruction;
a serial transmit bus circuit configured to serially transmit, to a FLASH memory, the transmit packet on a differential two-wire transmit (Tx) bus; and
a serial return bus circuit configured to receive, from the FLASH memory, a return packet serially transmitted on a differential two-wire return (Rx) bus, the return packet not in response to the transmit packet.

22. The storage control circuit of claim 21, the serial return bus circuit further configured to receive, from the FLASH memory, a second return packet serially transmitted on the differential two-wire return (Rx) bus in response to the transmit packet.

23. A FLASH memory in a solid-state drive (SSD) circuit, the FLASH memory comprising:
at least one non-volatile memory (NVM) die configured to store data;
a serial transmit bus circuit configured to receive a transmit packet comprising a FLASH instruction on a differential two-wire transmit (Tx) bus;
a FLASH control circuit configured to:
access the at least one NVM die in response to the FLASH instruction in the transmit packet; and
generate a return packet not in response to the FLASH instruction, the return packet comprising an instruction; and
a serial return bus circuit configured to serially transmit, to a storage control circuit, the generated return packet.

24. The FLASH memory of claim 23, wherein the FLASH control circuit is configured to generate a second return packet in response to the FLASH instruction, the second return packet comprising a response to the FLASH instruction.
